(19) United States
(12) Patent Application Publication
(10) Pub. No.: US 2006/0219796 A1
(43) Pub. Date: Oct. 5, 2006

(54) Integrated circuit chip card capable of determining external attack

(76) Inventor: Ji-Myung Na, Suwon-si (KR)

Correspondence Address: HARNESS, DICKEY & PIERCE, P.L.C., P.O. BOX 8910, RESTON, VA, 20195, US

(21) Appl. No.: 11/302,426

(22) Filed: Dec. 14, 2005

(30) Foreign Application Priority Data
Dec. 15, 2004 (KR) 2004-106395

(51) Int. Cl. G06K 19/06

(52) U.S. Cl. 235/492

(57) ABSTRACT

Example embodiments of present invention disclosed herein are directed to an IC chip card capable of detecting an external attack on data of a memory device. An IC chip card may include a memory device adapted to store data including a stored integrity identification value, an integrity identification value generating unit adapted to calculate an integrity identification value of the data, and a microprocessor adapted to compare the stored integrity identification value with the calculated integrity identification value to determine whether the data of the memory device has been compromised.

### PRIORITY STATEMENT

A claim of priority under 35 U.S.C. § 119 is made to Korean Patent Application No. 2004-106395 filed on Dec. 15, 2004, the entire contents of which are hereby incorporated by reference.

### Field of the Invention

Example embodiments of the present invention generally relate to an integrated circuit (IC) chip card, for example, a smart card. In particular, example embodiments of the present invention relate to an IC chip card capable of determining whether data of the IC chip card has been attacked by an external source.

### BACKGROUND OF THE INVENTION

Generally, integrated circuit (IC) chip cards are capable of processing various transactions. An IC chip card may include a microprocessor, card operation systems, security modules, and memories. IC chip cards may have a security advantage over conventional magnetic stripe cards. For example, data cannot be easily erased in an IC chip card. Accordingly, IC chip cards may be considered the next generation of information media devices. However, as IC chip cards have increasingly been used in finance, communications, distribution, and other industries, security concerns regarding the IC chip cards have increased.

Conventionally, an IC chip card has been protected from external attacks, for example, hacking, by the use of detectors capable of detecting current, temperature, frequency, and light fluctuations, and also de-capsulation of the IC chip. If a fluctuation occurs, internal circuits including the microprocessors may be reset when at least one of the detectors outputs a detection signal. However, data may be lost or damaged by an external attack or an abnormal operation by a circuit. In addition, the detectors may not easily detect logical invasions, because the detectors may not be distributed throughout the entire IC chip card, but rather detectors may be located in limited regions. In addition, it may be difficult to detect external attacks from non-detectable light, temperature, and/or frequency.

### SUMMARY OF THE INVENTION

In an example embodiment of the present invention, an integrated circuit (IC) chip card includes a memory device adapted to store data including a stored integrity identification value, an integrity identification value generating unit adapted to calculate an integrity identification value of the data, and a microprocessor adapted to compare the stored integrity identification value with the calculated integrity identification value to determine whether the data of the memory device has been compromised.

In another example embodiment of the present invention, a method of detecting whether data of a memory device in an integrated circuit (IC) chip card has been compromised includes receiving a stored integrity identification value output from the memory device, calculating an integrity identification value for the data of the memory device, and comparing the calculated integrity identification value with the stored integrity identification value to determined whether the data of the memory device has been compromised.

### BRIEF DESCRIPTION OF THE DRAWINGS

The accompanying drawings are included to provide a further understanding of example embodiments of the invention, and are incorporated in and constitute a part of the specification. The drawings illustrate example embodiments of the present invention and, together with the description, serve to explain principles of the present invention, wherein in the drawings:

FIG. 1 illustrates a block diagram of an IC chip card according to an example embodiment of the present invention;

FIG. 2 illustrates details of the integrity identification value generation unit 70 of FIG. 1;

FIG. 3 illustrates a Cyclic Redundancy Check (CRC) calculation result when data has not changed; and

FIG. 4 illustrates a CRC calculation result when data has changed by an external attack.

### DETAILED DESCRIPTION OF EXAMPLE EMBODIMENTS

Hereinafter, example embodiments of the present invention in conjunction with the accompanying drawings will be described. Although example embodiments of the present invention will be described, the present invention is not limited thereto. It will be apparent to those skilled in the art that various substitution, modifications and changes may be thereto without departing from the scope of the invention. Like reference numerals refer to similar or identical elements throughout the specification and the drawings.

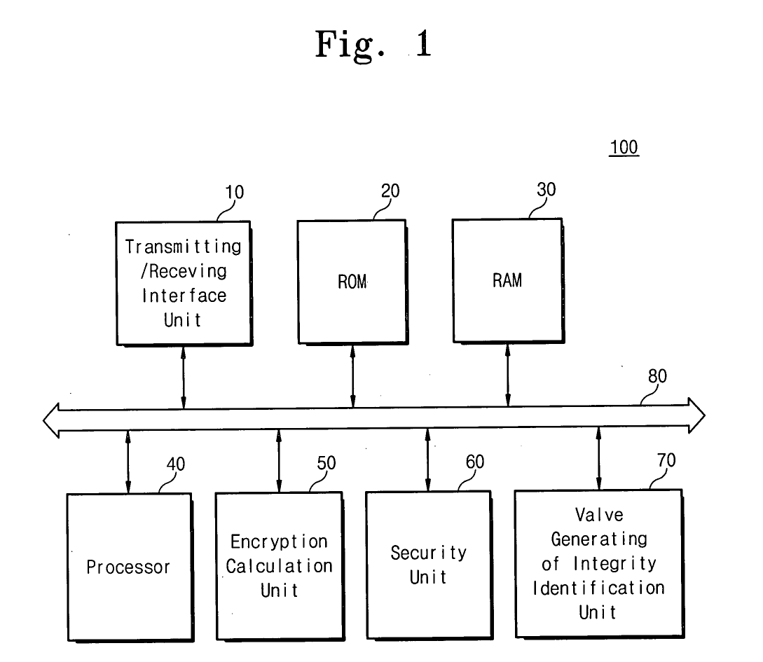

FIG. 1 a block diagram of an IC chip card (for example, a smart card) according to an example embodiment of the present invention. An IC chip card 100 may include a transmitting/receiving interface unit 10, a Read Only Memory (ROM) 20, a Random Access Memory (RAM) 30, a processor 40, for example, central processing unit (CPU), an encryption calculation unit 50, a security unit 60, and/or an integrity identification value generating unit 70.

The transmitting/receiving interface unit 10 may transfer data, addresses, and/or commands between the IC chip card 100 and an external device (not shown). The ROM 20 may be used as a program memory, and may set a command operating system and a basic command. The RAM 30 may manage temporary data and store interim calculation results in a working register. Although not shown in FIG. 1, the IC chip card 100 may further include a non-volatile memory (NVM), such as an Electrically Erasable and Programmable Read-Only Memory (EEPROM). The NVM may be used to store various data and optional programs. The NVM may read, write, and/or erase data depending on an operation of the IC chip card 100. The processor 40 may control internal paths to thereby control the data to and from the ROM, RAM, and/or NVM. The encryption calculation unit 50 may encrypt data to prevent the data from being exposed to non-authorized access. The security unit 60 may include one or more detectors. The detector(s) may detect light, , and/or frequency variations in the IC chip card.

According to an example embodiment of the present invention, to determine the integrity of programming data, a calculation unit 75 may be used to determine whether data has been tampered with by comparing an integrity identification value with a previously calculated and stored integrity identification value.

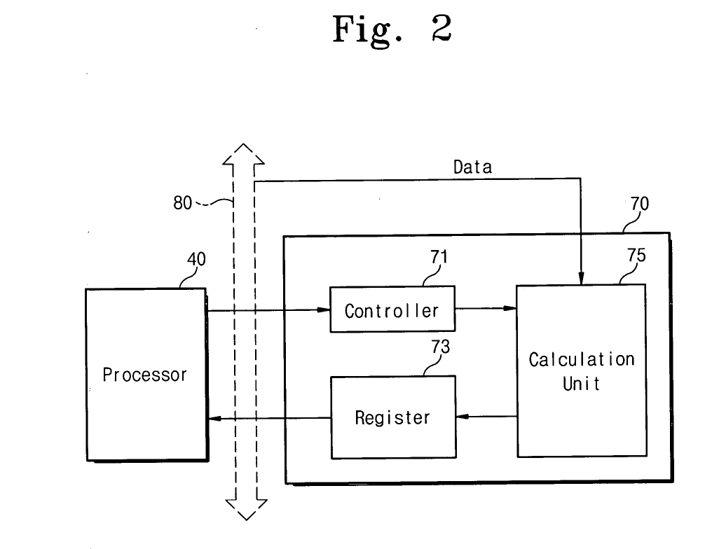

FIG. 2 illustrates details of the integrity identification value generation unit 70 of FIG. 1.

The integrity identification value generation unit 70 may include a controller 71, a storage register 73, and/or a calculation block 75. The controller 71 may detect the processor 40, a memory (e.g., ROM, RAM, and/or NVM) and the memory's operational state (e.g., writing, reading, and/or erasing). Accordingly, based on the detected information, the controller 71 may control the calculation unit 75. The calculation block 75 may receive data from a bus 80 and calculate the data. The calculation block 75 may receive data from the bus 80 and obtain the integrity identification value independent of the processor 40. Therefore, additional calculation time may be unnecessary.

The integrity identification value obtained from the calculation of the data may be stored in the storage register 73. A calculation for generating an integrity identification value can be performed by dividing each of memories into the operation state of the memory. Therefore, an example embodiment of the present invention may detect whether data has been compromised by only selecting data necessary to be protected. In addition, if the processor 40 is writing to the memory, and information such as a high-voltage is applied to the controller 71, the controller 71 may automatically stop a calculation, because prior to actual writing the memory, a dummy high-voltage may be applied to the memory, and therefore a calculation is not needed. When the high voltage is disabled, the calculation is continued.

According to an example embodiment of the present invention, an integrity identification value stored in a memory (e.g., ROM, RAM, and/or NVM) is calculated prior to when a command is applied to an IC chip card for the first time or before the IC chip card is provided to a user, and then the data values, together with the integrity identification value, may be stored in the memory. The integrity identification value (IIV) can be obtained by using the integrity identification value generation unit 70 and a separate program. The processor 40 may receive an integrity identification value from the storage register 73 and compare the IIV with the integrity identification value that was previously calculated and stored in memory. The processor 40 may detect whether or not data has been compromised. In an example embodiment, if both the values are equal, the data has not been compromised. If the compared values are not equal, the data has been compromised by an external attack. Accordingly, it is possible to protect internal data from damage by performing subsequent operations such as a rest or stop operation.

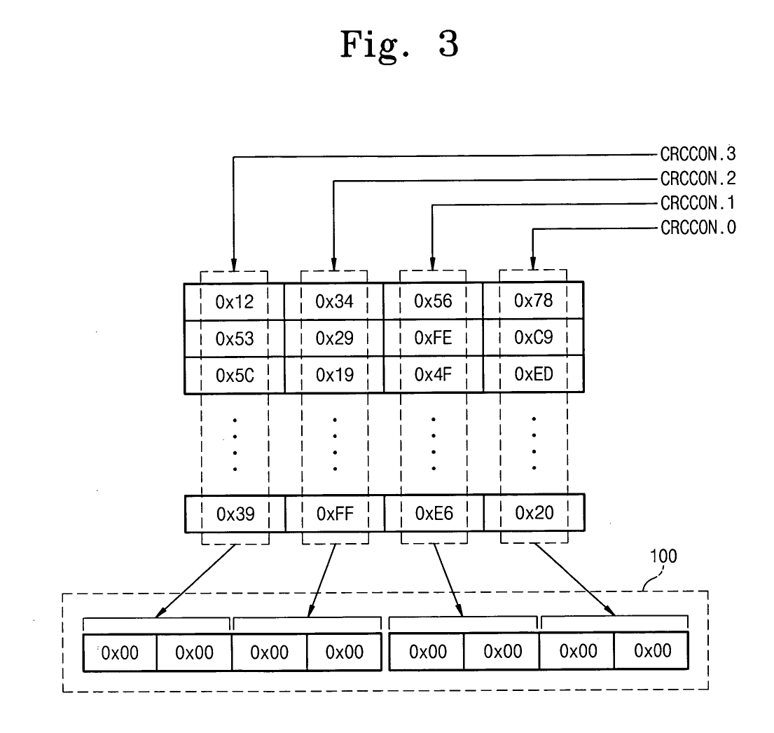

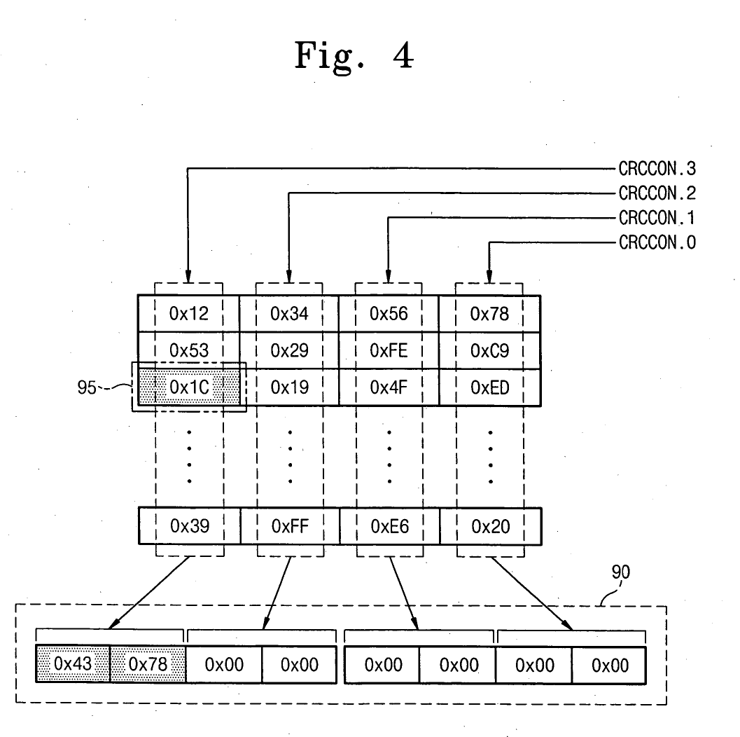

FIGS. 3 and 4 are examples illustrating a cyclic redundancy check (CRC) algorithm, a type of integrity identification calculation, which may be used in an example embodiment of the present invention. The principle of a CRC algorithm is as follows. Assuming there is n-bit data, the n-bit data is divided by a selected k-bit number. As a result, an r-bit is the remainder. At transmission, the CRC algorithm transmits the n+r bits data by dividing the transmitted data into k-bit and adding the r-bit remainder. Upon receipt, the received n+r bit data is divided by a key value, and the value of whether the remainder is 0 is determined. If the remainder is 0, the data was accurately received. If the remainder is not 0, the data was compromised during transmission.

In an example embodiment of the present invention, if the bus 80 processes data in units of bytes, one CRC calculator may be provided for each byte. An “exclusive or” (XOR) and a shift register may perform the CRC calculation, which may be capable of processing an input of 8-bits in parallel. Referring to FIG. 3, a plurality of control signals CRCCON. 0˜3 may be applied to the calculation unit 75. Each of the control signals can be in a byte mode, a half word mode, and/or a word mode. In the byte mode, one calculator may be enabled; in the half word mode, two calculators may be enabled; and in the word mode, four calculators may be enabled. If during the transmission of data, noise is generated, for example, in the bus 80, possibly due to an external attack (e.g., hacking), the CRC calculation is performed. During data transfer, if there is no damage to the data caused by an external attack, as shown in FIG. 3, all values by the CRC calculation 100 may be “0” As shown in FIG. 4, however, if data is changed due to the external attack (95), for example, one bit value is changed from 0*5C to 0*1C, at least one among the CRC calculation values 90 is not “0”. In other words, it is possible to determine whether data has been compromised by an external attack during the transmission of data by confirming the result by performing the CRC calculation with respect to the transmitting/receiving data.

Although the present invention has been described in connection with example embodiments of the present invention illustrated in the accompanying drawings, it is not limited thereto. It will be apparent to those skilled in the art that various substitution, modifications and changes may be thereto without departing from the scope of the invention.

What is claimed is:

1. An IC chip card comprising:
a memory device adapted to store data including a stored integrity identification value;
an integrity identification value generating unit adapted to calculate an integrity identification value of the data; and
a processor adapted to compare the stored integrity identification value with the calculated integrity identification value to determine whether the data of the memory device has been compromised.

2. The IC chip card as set forth in claim 1, wherein the integrity identification value generation unit comprises:
a calculation unit adapted to perform the integrity identification calculation on the data; and
a controller adapted to determine whether the calculation unit is performing an operation on the memory device by receiving operation condition information from the processor.

3. The IC chip card as set forth in claim 2, wherein the calculated integrity identification value is calculated by a Cyclic Redundancy Check (CRC) algorithm or a parity check algorithm.

4. The IC chip card as set forth in claim 3, wherein the CRC algorithm is performed by at least one exclusive or (XOR) and a shift register.

5. The IC chip card as set forth in claim 1, wherein the processor is a central processing unit (CPU), and wherein the CPU enters a rest or stop mode when the data of the memory device has been compromised.

6. The IC chip card as set forth in claim 1, wherein the memory device includes at least one of a read only memory (ROM), random access memory (RAM), and a non-volatile memory (NVM).

7. The IC chip card as set forth in claim 6, wherein the NVM includes electrically erasable programmable read-only memory (EEPROM).

8. The IC chip card as set forth in claim 2, wherein the calculation unit includes a plurality of calculators adapted to perform calculations by decollating data in a byte unit.

9. The IC chip card as set forth in claim 1, wherein the integrity identification value generation unit includes a register adapted to store the calculated integrity identification value.

10. The IC chip card as set forth in claim 1, further comprising:
a transmitting/receiving interface unit adapted to interface with an external device;
an encryption calculation unit adapted to encrypt the data of the memory;
a security unit adapted to detect external physical attacks to the IC chip card; and
a bus adapted to transfer data between the encryption calculation unit and the security unit, including the memory device.

11. A method of detecting whether data of a memory device in an IC chip card has been compromised, comprising:
receiving a stored integrity identification value output from the memory device;
calculating an integrity identification value for the data of the memory device; and
comparing the calculated integrity identification value with the stored integrity identification value to determine whether the data of the memory device has been compromised.

12. The method as set forth in claim 11, wherein the calculated integrity identification value is calculated by a Cyclic Redundancy Check (CRC) algorithm or a parity check algorithm.

13. The method as set forth in claim 11, wherein the integrity identification value is calculated when noise is detected.

14. The method as set forth in claim 11, further comprising:
performing a reset or stop mode when the data of the memory device has been compromised.

15. The method as set forth in claim 12, wherein the CRC algorithm is performed by at least one exclusive or (XOR) and a shift register.
